(19) United States
(12) Patent Application Publication
(10) Pub. No.: US 2025/0138211 A1
(43) Pub. Date: May 1, 2025

(54) SURFACE-CONSISTENT TRAVEL-TIMES INVERSION WITH ACCURACY ESTIMATION

(71) Applicant: Saudi Arabian Oil Company, Dhahran (SA)

(72) Inventors: Diego Rovetta, Delft (NL); Daniele Colombo, Dhahran (SA)

(21) Appl. No.: 18/497,606

(22) Filed: Oct. 30, 2023

(51) Int. Cl. G01V 1/32; G01V 1/28; G01V 1/30

(52) U.S. Cl. CPC G01V 1/325; G01V 1/282; G01V 1/305; G01V 2210/42; G01V 2210/665

(57) ABSTRACT

A method, system, and non-transitory computer readable media for seismic imaging of a subterranean formation. The operations include receiving data representing seismic traces corresponding to seismic waves propagating in the subterranean formation, and determining, from the seismic traces, travel time data and a data covariance matrix. The operations include determining a prior velocity model and a prior model covariance matrix for common midpoint locations and generating an objective function based on the travel time data, the data covariance matrix, the prior velocity model, and the prior model covariance matrix. The operations include determining, by minimizing the objective function, values for one-dimensional velocity models and a set of accuracy values. The operations include generating a pseudo-3D model and a set of accuracy values for the pseudo-3D model. Based on the pseudo-3D model and the set of accuracy values for the pseudo-3D model, a seismic image representing the subterranean formation is generated.

### TECHNICAL FIELD

This specification relates generally to geophysical exploration, and more particularly to seismic surveying and processing of seismic data.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications including identification of potential petroleum reservoirs. Seismic surveys are conducted by using a controlled seismic source (for example, a seismic vibrator or dynamite) to create seismic waves. The seismic source is typically located at ground surface. Seismic body waves travel into the ground, are reflected by subsurface formations, and return to the surface where they recorded by sensors called geophones. Seismic surface waves travel along the ground surface and diminish as they get further from the surface. Seismic surface waves travel more slowly than seismic body waves. The geologists and geophysicists analyze the time it takes for the seismic body waves to reflect off subsurface formations and return to the surface to map sedimentary facies and other geologic features. Similarly, analysis of the time it takes seismic surface waves to travel from source to sensor can provide information about near surface features. This analysis can also incorporate data from sources, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

This specification describes systems and methods for determining and generating one-dimensional (1D) velocity profiles from refracted waves in a subterranean formation. Seismic images can be generated from a pseudo three-dimensional (3D) model compiled from the 1D velocity profiles, to identify near-surface refraction characteristics represented in seismic traces from seismic surveys of the subterranean formation. The 1D velocity profiles (e.g., models representing velocity) are determined by an inversion of the observed first break travel times (e.g., observed data) extracted from the seismic traces, by minimizing an objective function. The objective function is based on a data misfit part (e.g., the weighted L2 normed difference between observations and data recalculated by the estimated model) and there are some regularization parts that introduce model constraints (e.g., the smoothing regularization, which is imposing smoother variations of the model parameters with depth and the reference model regularization, providing the solution that is numerically close to a reference model). A minimization of the objective function provides the optimum model (e.g., minimizing the data misfit) that is satisfying the constraints. Information about data (e.g., travel times) and prior model (e.g., prior velocities) uncertainties can be incorporated into the objective function. An output of the inversion can also provide the accuracy of the solution (e.g., posterior velocities).

The techniques described in this specification include the surface-consistent framework to build a velocity model of a subterranean formation by compiling multiple 1D velocity profiles that are independently determined. The 1D profile is based on velocity model parameters characterizing the subterranean formation at particular depths or layers, resulting from a minimization of an objective function that injects data uncertainty and model uncertainties. By injecting uncertainties from covariances of the observed first-break travel times extracted from seismic traces and of the prior model, the inversion process also provides a measurement of the accuracy for the 1D velocity profile. The objective function can be minimized using iterative minimization techniques to determine a 1D velocity profile.

Some approaches for generating velocity models include converting travel times as a function of offset, e.g., the distance between a controlled seismic source and receiver, into velocities as a function of depth. These approaches do not account for statistical uncertainties in the travel time data when determining a velocity profile, thereby resulting in low-accuracy velocity models. Other approaches for velocity modeling include generating a 3D model of the subterranean formation based on seismic data of refracted waves but can be computationally demanding due to vast amounts of data in 3D space, e.g., compared to lower-dimensional representations. Computational demands for generating velocity models using 3D-based techniques can drastically increase when incorporating additional parameters, such as uncertainties from the seismic data or prior model, to improve the accuracy of the velocity models. Furthermore, seismic images generated from velocity models with improved accuracy result in improvements in image resolution of the seismic images.

Embodiments of these systems and methods can include one or more of the following features.

In an aspect, a method for performing seismic imaging of a subterranean formation includes receiving, by a computer system, data representing a plurality of seismic traces corresponding to seismic waves propagating in the subterranean formation; determining, from the plurality of seismic traces, travel time data representing observed travel times of refracted energy and a data covariance matrix representing uncertainty associated with the observed travel times for the plurality of seismic traces; determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model; generating an objective function based on the travel time data, the data covariance matrix, the prior velocity model, and the prior model covariance matrix; determining, by minimizing the objective function, values for a plurality of one-dimensional velocity models and a set of accuracy values associated with the plurality of one-dimensional velocity models; generating, based on the values for the plurality of one-dimensional velocity models and the set of accuracy values, a pseudo-3D model and a set of accuracy values for the pseudo-3D model; and generating, based on the pseudo-3D model and the set of accuracy values for the pseudo-3D model, a seismic image representing the subterranean formation.

In some implementations, each one-dimensional velocity model corresponds to a respective common midpoint location from the plurality of common midpoint locations.

In some implementations, generating the pseudo-3D model includes performing, by the computer system, a full waveform inversion of the travel time data using the plurality of one-dimensional velocity models.

In some implementations, generating the pseudo-3D model includes interpolating, by the computer system, the plurality of one-dimensional velocity models to generate the pseudo-3D model of the plurality of common midpoint locations.

In some implementations, the method further includes determining, based on an inversion of the observed travel times and using (i) the data covariance matrix, (ii) the prior velocity model, and (iii) the prior model covariance matrix, a posterior model covariance matrix; and determining, based on the posterior model covariance matrix, a measurement accuracy of the plurality of one-dimensional velocity models.

In some implementations, the travel time data represents a subset of clean travel times from the observed travel times of refracted energy of the plurality of seismic traces, wherein the subset of clean travel times includes travel times from the observed travel times that are within a threshold value of a first statistical measure of the observed travel times, wherein the threshold value is a second statistical measure of the observed travel times, the second statistical measure different from the first statistical measure.

In some implementations, generating the objective function further includes applying a smoothing operator to the prior velocity model.

In some implementations, determining the inverse of the data covariance matrix further includes applying a filter to the data covariance matrix. The filter is based on a minimum number of offsets in a corresponding common midpoint-offset bin for the plurality of seismic traces. In some implementations, determining the inverse of the data covariance matrix further includes applying a filter to the data covariance matrix based on a minimum travel time and a maximum travel time from the travel time data from the plurality of seismic traces. In some implementations, determining the inverse of the data covariance matrix further includes applying a filter to the data covariance matrix based on a standard deviation of travel times in the travel time data from the plurality of seismic traces. The standard deviation is a median absolute deviation of the travel times in the travel time data from the plurality of seismic traces.

In some implementations, minimizing the objective function includes performing a number of iterations until an update for the one-dimensional velocity model is below a threshold value.

In an aspect, a system for performing seismic imaging of a subterranean formation includes at least one processor and a memory storing instructions that, when executed by the at least one processor, cause the at least one processor to perform operations. The operations include receiving, by a computer system, data representing a plurality of seismic traces corresponding to seismic waves propagating in the subterranean formation; determining, from the plurality of seismic traces, travel time data representing observed travel times of refracted energy and a data covariance matrix representing uncertainty associated with the observed travel times for the plurality of seismic traces; determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model; generating an objective function based on the travel time data, the data covariance matrix, the prior velocity model, and the prior model covariance matrix; determining, by minimizing the objective function, values for a plurality of one-dimensional velocity models and a set of accuracy values associated with the plurality of one-dimensional velocity models; generating, based on the values for the plurality of one-dimensional velocity models and the set of accuracy values, a pseudo-3D model and a set of accuracy values for the pseudo-3D model; and generating, based on the pseudo-3D model and the set of accuracy values for the pseudo-3D model, a seismic image representing the subterranean formation.

In an aspect, one or more non-transitory computer readable media storing instructions to perform seismic imaging of a subterranean formation, the instructions, when executed by at least one processor, configured to cause the at least one processor to perform operations. The operations include receiving, by a computer system, data representing a plurality of seismic traces corresponding to seismic waves propagating in the subterranean formation; determining, from the plurality of seismic traces, travel time data representing observed travel times of refracted energy and a data covariance matrix representing uncertainty associated with the observed travel times for the plurality of seismic traces; determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model; generating an objective function based on the travel time data, the data covariance matrix, the prior velocity model, and the prior model covariance matrix; determining, by minimizing the objective function, values for a plurality of one-dimensional velocity models and a set of accuracy values associated with the plurality of one-dimensional velocity models; generating, based on the values for the plurality of one-dimensional velocity models and the set of accuracy values, a pseudo-3D model and a set of accuracy values for the pseudo-3D model; and generating, based on the pseudo-3D model and the set of accuracy values for the pseudo-3D model, a seismic image representing the subterranean formation.

The approaches described in this specification provide systems and methods that provide the following advantages.

Determining and generating 1D pseudo velocity profiles of refracted waves in a subterranean formation can provide numerous advantages in better identifying shallow subsurface geological features, estimating velocities of the refracted waves with higher accuracy, providing a quantitative measure of such accuracy, reducing computational complexity, e.g., increasing computational savings. The improved accuracy in velocity modeling from injecting data and prior model uncertainties can result in high-resolution seismic images of seismic features, thereby resulting in improved classification of the seismic features in seismic surveying. The improved seismic maps can be generated from velocity models obtained with fewer computational resources and lower computational complexity by compiling multiple 1D velocity profiles that can be processed in parallel, in contrast to dense 3D models that require higher computational costs. Further, multiple 1D inversions of velocity models can be more readily parallelized than inversions of 3D velocity models due to the reduced dimensionality. Injecting data and prior model uncertainties also provides a quantitative parameter to evaluate the accuracy of the estimated 1D velocity profiles.

The details of one or more embodiments are set forth in the accompanying drawings and the description below. Other features and advantages will be apparent from the description and drawings, and from the claims.

### BRIEF DESCRIPTION OF THE DRAWINGS

FIG. 1A is a schematic view of a seismic survey being performed to map subterranean features such as facies and faults.

FIG. 1B illustrates incident and reflected rays at a common midpoint (CMP) position compared to refracted ray paths.

FIG. 1C illustrates an example ray path of refracted wave paths in a seismic survey.

FIG. 2 illustrates a three-dimensional (3D) cube representing the seismic data in the CMP-offset domain.

FIG. 3 illustrates a stratigraphic trace extracted by a bin of the 3D cube of FIG. 2.

FIGS. 4A-4C illustrate normal moveout correction and stacking a set of seismic traces.

FIG. 5A shows an example process for determining one-dimensional velocity models from seismic traces.

FIG. 5B shows an example process of filtering the observed travel times data and generating an inverse of a data covariance matrix.

FIGS. 6A and 6B are plots of an example of statistical measures of travel times.

FIG. 7A is a plot of an example conversion of travel times to generate a velocity model.

FIGS. 7B and 7C are plots of an example inversion using statistical measures of travel times.

FIG. 7D is a plot of another example conversion of travel times to generate a velocity model.

FIGS. 7E and 7F are plots of another example inversion using statistical measures of travel times.

FIGS. 8A-8C are plots of example estimated accuracy from inverting travel times.

FIGS. 8D-8F are plots of another example estimated accuracy from inverting travel times.

FIG. 9 is a diagram of an example data processing system.

FIG. 10 illustrates example hydrocarbon production operations.

### DETAILED DESCRIPTION

A transmission-based framework for seismic imaging includes transmitting and receiving seismic waves between a controlled seismic source and a group of receivers. Generating a velocity model of a subterranean formation based on seismic and other data obtained from the subterranean formation can include accounting for physical characteristics of the seismic data acquisition process. The travel time of a refracted seismic wave can be represented as a function of parameters that include the depth of a refracting horizon, and the offset between the source generating the wave and the sensor observing arrival of the seismic wave at a particular location.

One-dimensional velocity profiles (also referred to “1D velocity models” or “1D compressional velocity models”) based on inversion of travel time data can provide a pseudo three-dimensional (3D) model by compiling the 1D velocity models, or performing full-waveform inversion starting from the 1D velocity models as initial model, or some combination thereof. The 1D velocity model results from minimizing an objective function including statistical uncertainties from the travel time data and prior model, e.g., by inverting observed first break travel times from the seismic traces with some additional constraints on the model. A posterior covariance matrix can be determined from the objective function, thereby tracking accuracy of the solution and characterizing utility of the 1D velocity profiles, e.g., for generating the pseudo-3D model and seismic images of the subterranean features.

A 3D model can be generated from the 1D velocity models by 3D full-waveform inversion of the 3D travel times. In some implementations, 3D tomography is performed by inverting 3D travel times from the 1D velocity models. In some implementations, the results of 1D full-waveform inversion or inversion of 1D travel times are interpolated to generate a 3D model. The interpolation of multiple 1D velocity models provides a computationally efficient manner to generate a 3D velocity model, e.g., compared to 3D full-waveform inversion or 3D tomography. The 1D velocity models can be combined and interpolated into a 3D model. Based on the 3D velocity model, a seismic image can be generated with high accuracy and more efficiently, e.g., compared to 3D full-waveform inversion of 3D tomography.

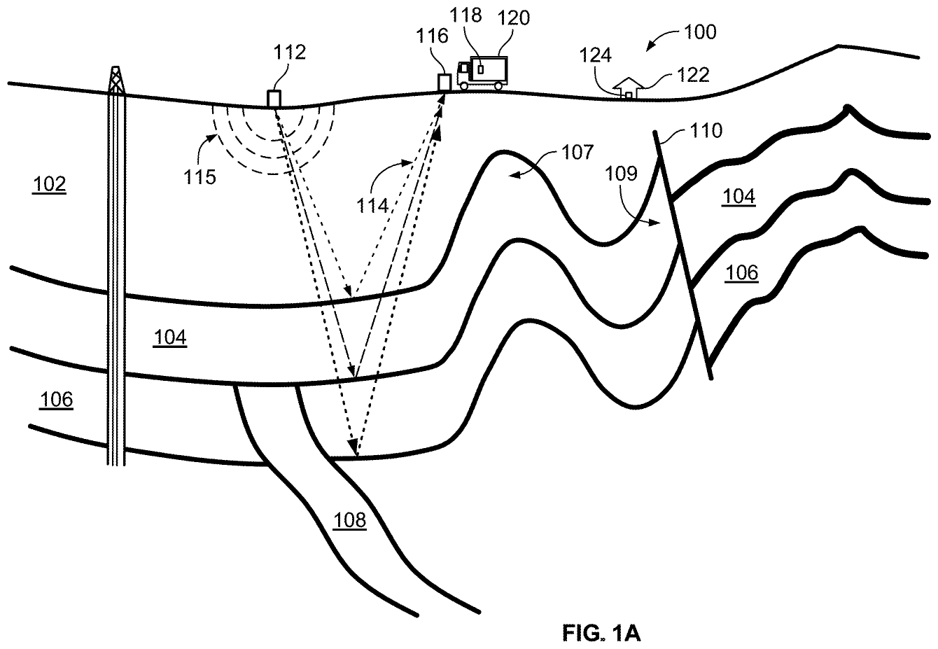

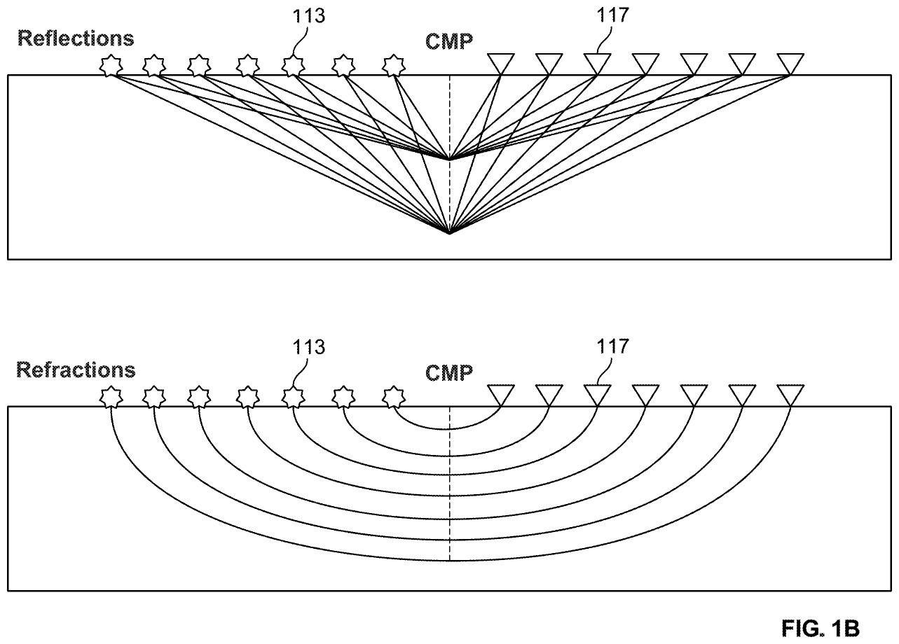

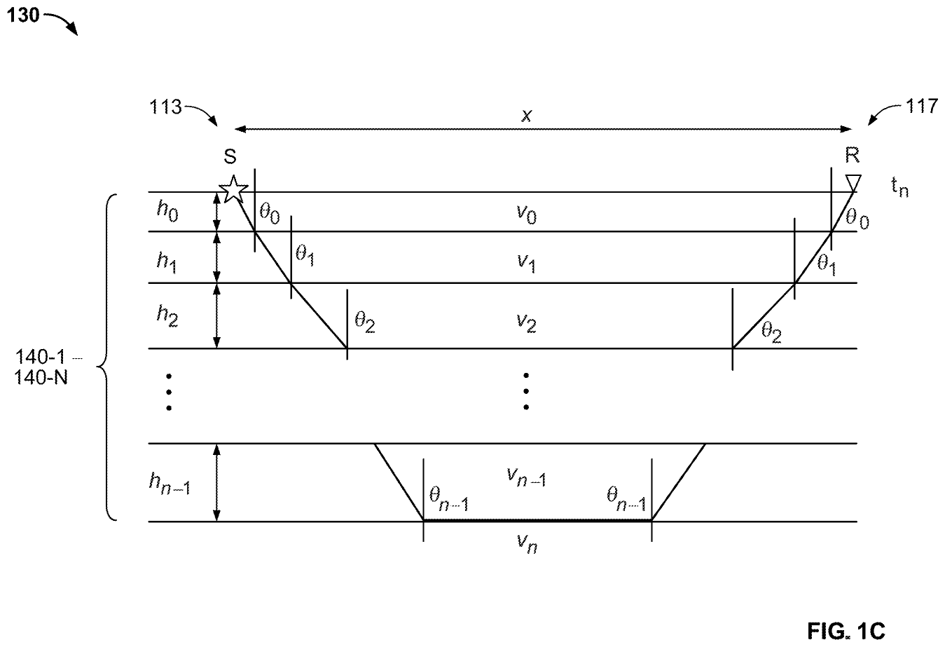

FIG. 1A is a schematic view of a seismic survey being performed to map subterranean features such as facies and faults in a subterranean formation 100 under a marine feature (such as under the sea or ocean). The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1A shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1A, the source or sources 112 are typically a line or an array of sources 112. The generated seismic waves include seismic body waves 114 that travel into the ground and seismic surface waves 115 travel along the ground surface and diminish as they get further from the marine surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1A, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer systems 124 may be displayed for user viewing using local or remote monitors or other display units. One approach to analyzing seismic data is to associate the data with portions of a seismic cube representing the subterranean formation 100. The seismic cube can also display results of the analysis of the seismic data associated with the seismic survey.

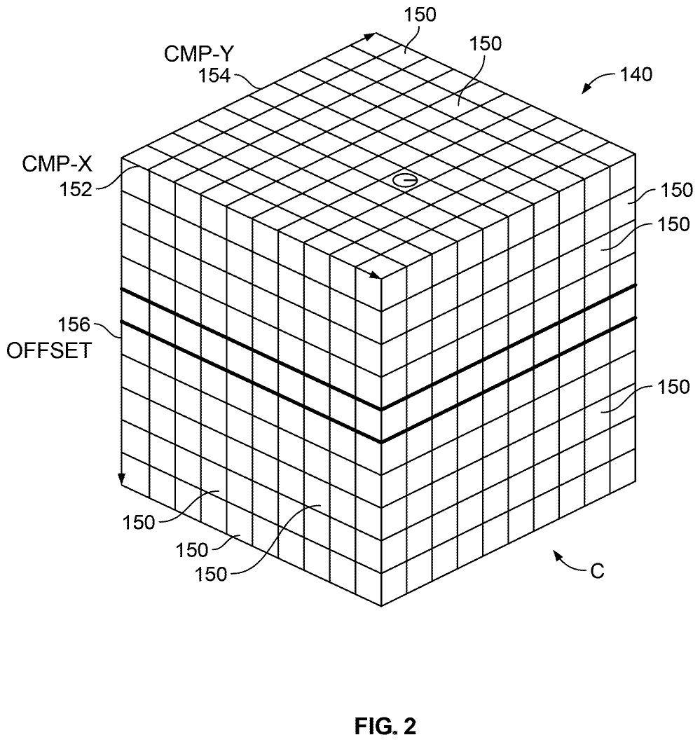

FIG. 1B illustrates incident and reflected rays at a common midpoint (CMP) position compared to refracted ray paths. In the idealized, one-dimensional (1D) model depicted in FIG. 1B (velocity increasing with depth), the offset (O) between a shot source (for example, source 113) and a receiver (for example, receiver 117) controls the depth of penetration of the refracted waves. For refracted waves, an effective and concise representation of the subsurface structure is obtained by sorting or binning traces in a CMP-offset domain (referred to as XYO binning). After binning the received seismic traces (or the first break picks), statistics are calculated for each bin (for example, mean, median, mode, standard deviation, and cross-correlation). Multidimensional binning is applied to a 3D dataset of seismic traces as shown in FIGS. 2-3.

FIG. 1C illustrates an example ray path 130 of refracted wave paths in a seismic survey, e.g., the seismic survey illustrated in FIG. 1A. The ray path 130 illustrates refracted wave paths traveling between a source, e.g., source 113, and a receiver, e.g., receiver 117, as previously described in reference to FIG. 1B through a layered medium with layers 140-1-140-N (collectively referred to as layers 140). The ray path 130 of refracted wave paths travels through some or all of layers 140 in which each layer includes a corresponding thickness. Further, refracted waves propagate through different layers of the layers 140 at varying velocities and incidence angles. For example, refracted waves propagate at each layer at a respective velocity and angle of incidence. The travel times of refracted waves along the ray path 130 at a particular layer n among layers 140 for the source 113 and receiver 117 at a distance x relative to each other can be described by equation (1) below:

$${t}_{n} ( {v}_{0} , {v}_{1} , … , {v}_{n} ) = 2 {\sum }_{i = 0}^{n - 1} \frac{{h}_{i}}{{v}_{i} cos {θ}_{i}} + \frac{1}{{v}_{n}} [ x - 2 {\sum }_{i = 0}^{n - 1} {h}_{i} tan {θ}_{i} ] \qquad ( 1 )$$

Equation 1 describes the travel times ty as a function of velocities v₀, v₁, . . . , vₙ between the source 113 and receiver 117 across the layers 140 of the refracted waves along the ray path 130, at an n^{th} layer of layers 140. At an i^{th} layer of layers 140, vᵢ represents the velocity between the source 113 and receiver 117 at the layer, hᵢ represents the thickness of the layer, and θᵢ represents the angle of incidence Furthermore, the angle of incidence between two adjacent layers of the layers 140 can be represented by Snell's Law in equation (2) below:

$$\frac{sin {θ}_{i}}{{v}_{i}} = \frac{sin {θ}_{i + 1}}{{v}_{i + 1}} \qquad ( 2 )$$

The total refraction of the refracted waves can occur at the n^{th} layer of layers 140, and thus Snell's Law describes a ratio of velocities between the n^{th} layer and the adjacent (n−1)th layer by sin θᵢ=1 and

$$sin {θ}_{n - 1} = \frac{{v}_{n - 1}}{{v}_{n}} .$$

Thus, equation (3) below describes a relationship between an angle of incidence at a particular i^{th} layer relative to the velocities of the refracted waves at a particular i^{th} layer and the n^{th} layer:

$$sin {θ}_{i} = \frac{{v}_{i}}{{v}_{n}} \qquad ( 3 )$$

By applying equation (3) to equation (1), the travel times of the refracted waves across layers 140 between the source 113 and receiver 117 by offset x (e.g., the distance between source 113 and receiver 117) can be represented by equation (4) below:

$${t}_{n} ( {v}_{0} , {v}_{1} , … , {v}_{n} ) = \frac{1}{{v}_{n}} [ x + 2 {\sum }_{i = 0}^{n - 1} {h}_{i} \frac{\sqrt{{v}_{n}^{2} - {v}_{i}^{2}}}{{v}_{i}} ] \qquad ( 4 )$$

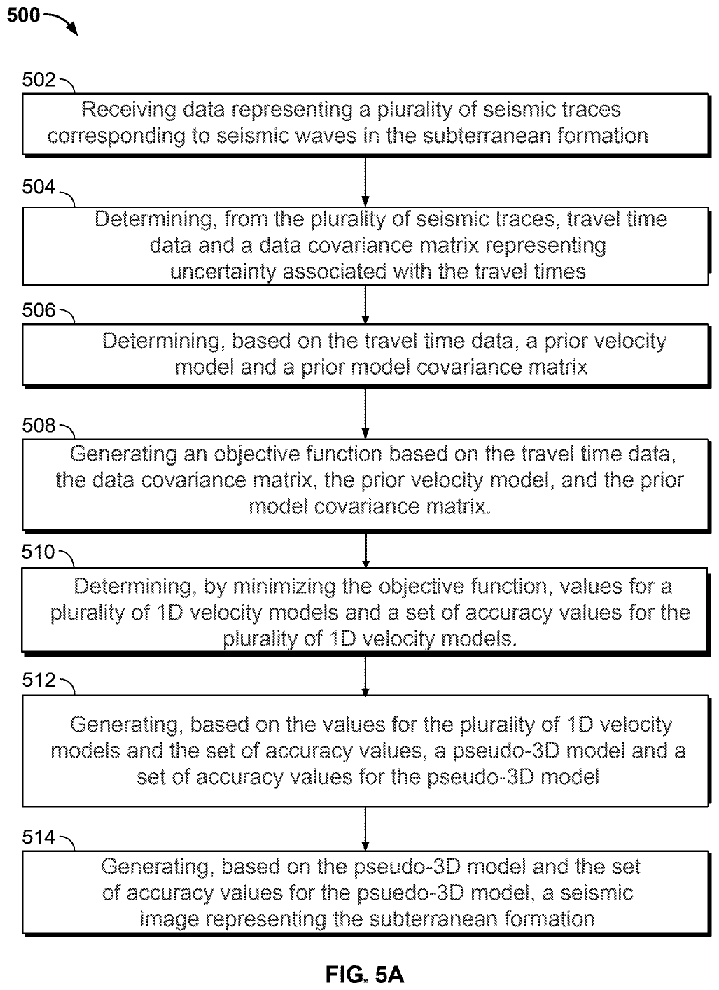

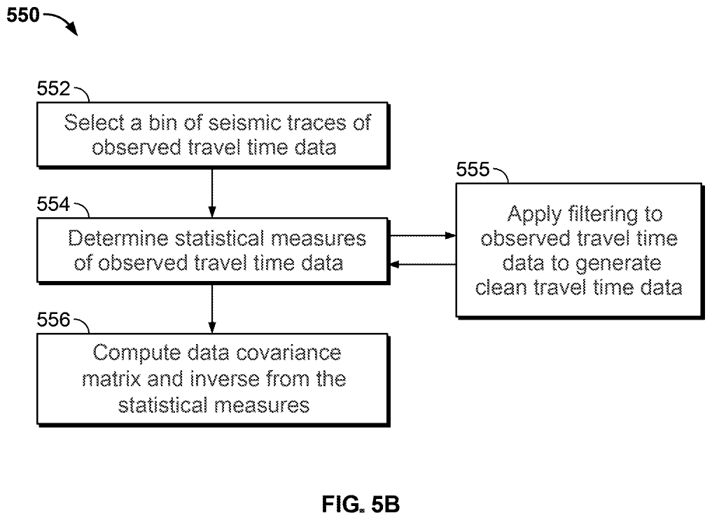

Equation (4) above represents the travel times of the refracted waves as a function of velocity vᵢ and layer thickness hᵢ without applying trigonometric functions to incident angles θᵢ, thus providing a relationship for velocity and travel time that is computationally efficient, e.g., compared to equation (1) above. Furthermore, equation (4) provides a direct relationship between observable travel time data between the source 113 and the receiver 117 from collecting seismic traces, and the unknown velocity parameters v₀, v₁, . . . , vₙ that can be estimated in a one-dimensional model, e.g., by inverting the travel times and minimizing an objective function described in reference to FIG. 5A below.

To compute the unknown velocity models through an inversion of the travel time data, a gradient of the travel times of refracted waves as a function of velocity is computed, e.g., taking the derivatives of travel times with respect to the velocities of equations (1) and (4) above.

For example, the gradient of equation (1) for the layers i=0, 1, 2, . . . n of layers 140 can be represented by equation (5) below for layers above the n^{th} layer (e.g., i<n) and at the n^{th} layer, (e.g., i=n):

$$\frac{\partial {t}_{n}}{\partial {v}_{i}} = - 2 \frac{{h}_{i}}{{v}_{i}^{2} cos {θ}_{i}} for i < n ; \qquad ( 5 )$$

$$\frac{\partial {t}_{n}}{\partial {v}_{n}} = - \frac{x - 2 {\sum }_{i = 0}^{n - 1} {h}_{i} tan {θ}_{i}}{{v}_{n}^{2}} for i = n ;$$

A gradient of equation (4) for the same respective layers can be represented by equations (6) and (7) below for layers above the n^{th} layer (e.g., i<n) and at the n^{th} layer, (e.g., i=n), respectively:

$$\frac{\partial t}{\partial {v}_{i}} = - \frac{2 {h}_{i} {v}_{n}}{{{v}_{i}}^{2} \sqrt{{{v}_{n}}^{2} - {{v}_{i}}^{2}}} for i < n ; \qquad ( 6 )$$

$$\frac{\partial t}{\partial {v}_{n}} = \frac{1}{{{v}_{n}}^{2}} [ 2 {\sum }_{i = 0}^{n - 1} \frac{{h}_{i} {v}_{i}}{\sqrt{{{v}_{n}}^{2} - {{v}_{i}}^{2}}} - x ] for i = n ; \qquad ( 7 )$$

FIG. 2 illustrates seismic trace sorting into CMP-offset bins 150. The multi-dimensional attribute cubes or bins are used for quality control since these cubes or bins 150 enable a visualization of the spatial trends of the travel time (mean values) and the noisy areas (standard deviation). When performing the 3D CMP-offset binning (that is, XYO binning in the directions of CMP-X 152, CMP-Y 154, and offset 156), the bin sizes in the CMP-X 152 and CMP-Y 154 directions can be kept greater, such that a sufficient number of CMPs are placed in a bin 150 to provide functionally applicable statistics. The XYO binning illustrated in FIG. 2 is different from sorting in a common offset domain as the latter collects data sharing a common offset but pertaining to different CMPs. The existing CMP sorting (time-offset) that is applied for reflected waves is less useful for refracted waves as it would display events with variable velocities over the offset axis. The XYO binning method is therefore an effective representation of both CMP and offset domains where common properties at a CMP position can be assessed.

In some implementations, as shown in FIG. 2, the XYO space 140 is divided into XYO cubes or bins 150 of a particular size. For example, each bin 150 can have a size of 100 meters (m) in the CMP-X direction, 100 m in the CMP-Y direction, and 50 m in the offset direction. For each trace (or first break pick), the offset (the distance between the source and the receiver) and the CMP (the middle point position between the source and the receiver) are determined, and the trace is sorted into a particular bin based on the offset and the CMP. Each XYO bin 150 includes a collection of traces sharing a common (or similar) midpoint position and a common (or similar) offset. The collection of traces in an XYO bin is sometimes referred to as an XYO gather.

FIG. 3 illustrates a seismic cube 200 representing a formation. The seismic cube has a stratum 202 based on a surface (for example, an amplitude surface 204) and a stratigraphic horizon 206. The amplitude surface 204 and the stratigraphic horizon 206 are grids that include many cells such as exemplary cell 208. Each cell is a sample of a seismic trace representing an acoustic wave. Each seismic trace has an x-coordinate and a y-coordinate, and each data point of the trace corresponds to a certain seismic travel time or depth (t or z). For the stratigraphic horizon 206, a time value is determined and then assigned to the cells from the stratum 202. For the amplitude surface 204, the amplitude value of the seismic trace at the time of the corresponding horizon is assigned to the cell. This assignment process is repeated for all of the cells on this horizon to generate the amplitude surface 204 for the stratum 202. In some instances, the amplitude values of the seismic trace 210 within window 212 by horizon 206 are combined to generate a compound amplitude value for stratum 202. In these instances, the compound amplitude value can be the arithmetic mean of the positive amplitudes within the duration of the window, multiplied by the number of seismic samples in the window.

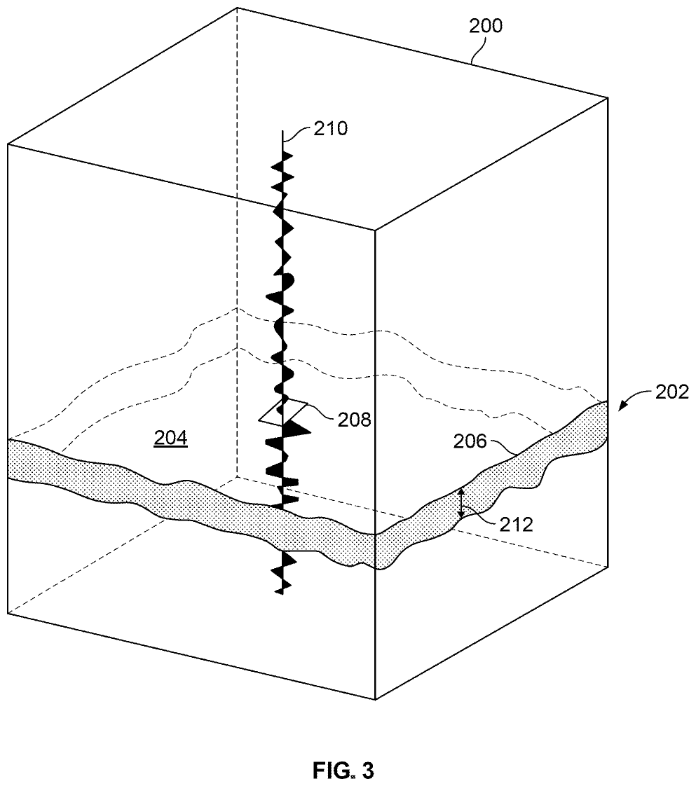

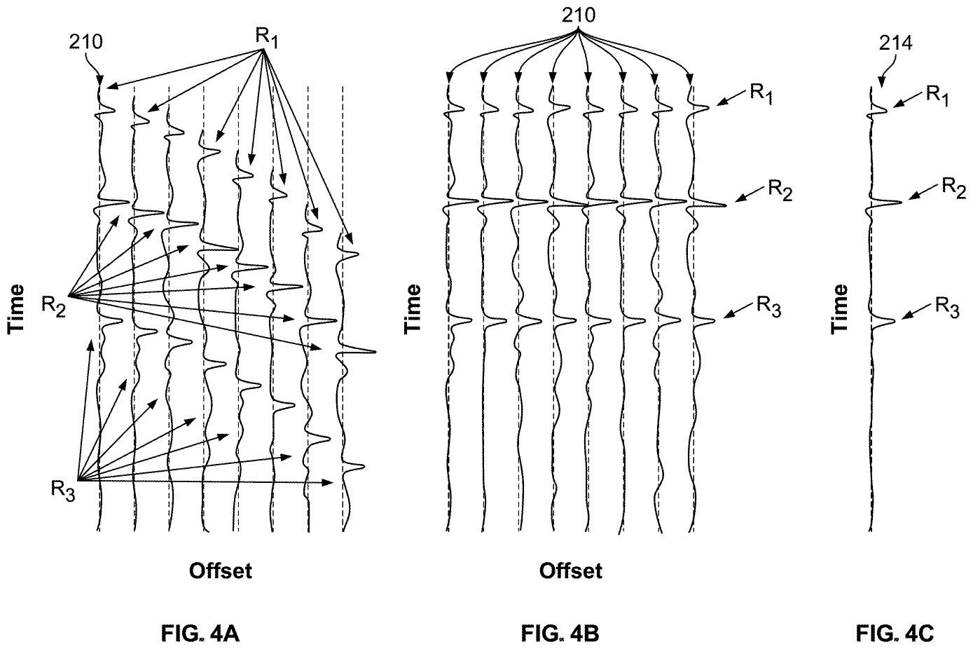

FIGS. 4A, 4B, and 4C schematically illustrate the process of stacking a group of seismic traces 210 to improve the signal to noise ratio of the traces. FIG. 4A illustrates a common midpoint (CMP) gather of eight of the seismic traces 210 generated by a set of sources and sensors that share a common midpoint. For ease of explanation, the traces are assumed to have been generated by reflections from three horizontal horizons.

The seismic traces 210 are arranged with increasing offset from the CMP. The offset of the seismic traces 210 from the CMP increases from left to right and the reflection time increases from top to bottom. Increasing offset from the common midpoint increases the angle of a seismic wave that between a source and a sensor, increases the distance the wave travels between the source and the sensor, and increases the slant reflection time. The increasing time for the reflections (R1, R2, R3) from each of the horizons to arrive for source-sensor pairs with increasing offsets from the CMP reflects this increased slant time.

FIG. 4B shows the seismic traces 210 after normal moveout (NMO) correction. NMO is the difference between vertical reflection time and the slant reflection time for a given source-sensor pair. This correction places reflections (R1, R2, R3) from common horizons at the same arrival time. The NMO correction is a function of the vertical reflection time for a specific horizon, the offset of a specific source-sensor pair, and the velocity of the seismic wave in the subterranean formation. The vertical reflection time for a specific horizon and the offset for a specific source-sensor pair are known parameters for each trace. However, the velocity is usually not readily available. As previously discussed, the velocity of seismic waves depends on properties, for example, density, porosity, and fluid content, of the medium through which the seismic waves are traveling and consequently varies with location in the subterranean formation be studied.

FIG. 4C shows a stack trace 214 generated by summing the seismic traces 210 of the CMP gather and dividing the resulting amplitudes by the number of traces in the gather. The number of traces in the gather is also referred to as the fold of the gather. The noise tends to cancel out and the reflections (R1, R2, R3) from the horizons of the subterranean formation are enhanced.

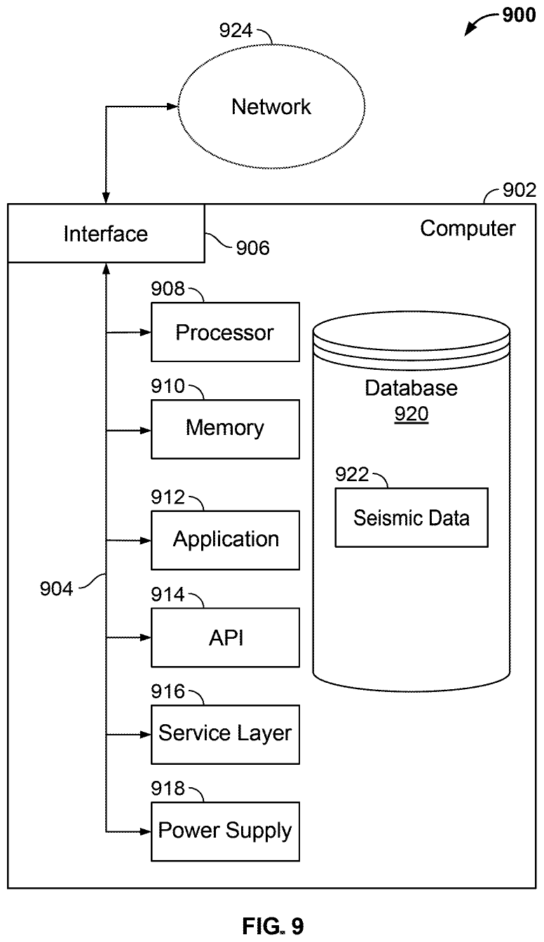

FIG. 5A illustrates process 500 for generating a 1D velocity model based on the inversion of travel time data. In some implementations, the process 500 is performed by a data processing system. Such a data processing system 900 is subsequently described in more detail in relation to FIG. 9.

In step 502, the data processing system receives data representing seismic traces, e.g., seismic traces 210 previously described in reference to FIGS. 3 and 4A-4C. Data representing the seismic trace includes time samples of the seismic wave, e.g., by a hypercube described in reference to FIG. 2 above. The seismic data can also include time-varying amplitude values for refracted waves, e.g., from an example ray path 130 previously described in reference to FIG. 1C.

In step 504, the data processing system determines travel time data representing observed travel times of refracted energy from the seismic traces, using measured travel times of refracted wave paths in the seismic survey. The travel time data can be represented by a data structure, e.g., vectors, matrices, tensors, and include values for first break travel times of refracted waves across different layers of seismic survey. The data processing system also determines the uncertainty of the observed travel times needed to build the data covariance matrix.

In some implementations, the data processing system performs a pre-processing step such as filtering, to determine clean travel times from the travel time data previously described in reference to FIG. 5B. The clean travel times represent travel times with outlier data removed from the observed travel times. The clean travel times are extracted from the observed travel times by using statistical measures of their values. Statistical measures (e.g., a mean and a standard deviation) are used to determine which travel times in the observed data represent outliers and where the threshold is set. If some travel times differ from their respective mean values for more than a specific number of their standard deviations (e.g., two times their standard deviation, or three times their standard deviation, or other such statistical based threshold) than these are considered outliers and filtered out of the observed data. The travel times from the observed travel times that are not filtered or removed by this process are the clean travel times.

The travel times that exceed a range of specified standard deviations are outliers that are excluded from the clean travel times. The data processing system also determines the uncertainty of the observed travel times to build the data covariance matrix. Sources of outliers can include measurement noise, as well as spurious events occurring in the subterranean formation.

In step 506, the data processing system determines a prior velocity model and a measure of uncertainty of the prior velocity model based on the travel time data. The measure of uncertainty of the prior velocity model is referred to as a prior model covariance matrix.

In step 508, the data processing system generates an objective function ¢ (m) based on the observed travel time data and associated uncertainty (also referred to as travel time data and travel time covariance matrix, respectively). The objective function is also generated based on the prior model and its uncertainty (also referred to as prior or reference velocity model and prior model covariance matrix, respectively). By minimizing the objective function, a data processing system can determine (velocity) model parameters associated to a one-dimensional velocity model.

The data processing system determines the objective function based on travel time data from observed travel times in seismic traces, modeled travel time data from estimated models, from data covariance matrix for both the observed travel time data and the modelled travel time data, from prior velocity model and prior model covariance matrix. Modelled travel times for a set of velocities for each subsurface layer are determined through equation (1) or equation (4) previously described in reference to FIG. 1C.

The objective function includes terms for data misfit, prior model misfit, and a model smoothing operator term, in which model parameters for a one-dimensional (1D) velocity profile can be determined. The minimization of the objective function corresponds to the simultaneous minimization of the data misfit, prior model misfit and model smoothing terms, providing 1D velocity models that achieve minimal misfits, e.g., by computing differences between observed and predicted data values and by computing differences between predicted and reference models and by computing a smoothing operator. A reference model can be built based on data from the subterranean formation. For example, an initial estimation of velocity at a depth of the subterranean formation can be determined based on collected geophysical data, which can be utilized to build the reference model. In some implementations, a reference model is a general velocity gradient. In some cases, the reference model is omitted from the objective function.

The data misfit term includes a non-linear forward operator g(m) to solve for the 1D velocity model m, the observed travel times d_{obs}, and the data covariance matrix C_{d} from the observed travel times d_{obs}. In more detail, the data misfit term (g(m)−d_{obs})^{T}C_{d}⁻¹(g(m)−d_{obs}) represents a difference between predicted and observed values for travel times that incorporates the inverse of the travel time covariance matrix C_{d}. The C_{d}⁻¹ term in the data misfit term incorporates measurement uncertainty from the observed travel time data to improve the representation of the observed data in the objective function, e.g., weighing some observed travel times over other observed travel times in the matrix multiplication. The C_{d}⁻¹ term also contains the modelling errors of the non-linear forward operator.

The prior model misfit term includes a 1D velocity model m to be solved and a prior model mₚᵣ that can be used to provide modeled travel times and model covariance matrix C_{M} for the objective function. The prior model misfit term (m−mₚᵣ)^{T}C_{M}⁻¹(m−mₚᵣ) represents a difference between the 1D velocity model m and the prior model mₚᵣ that also incorporates the inverse of the prior model covariance matrix C_{M}. The C_{M}⁻¹ term in the prior model misfit term incorporates uncertainty from the prior model, e.g., weighing some prior model parameters over other prior model parameters in the matrix multiplication.

The model smoothing operator term includes a model smoothing operator L, also referred to as the Laplacian smoothing operator. The model smoothing operator term applies the Laplacian smoothing operator while the objective function is being minimized, e.g., from one iteration to the next iteration in a root-finding technique, to adjust the model parameters for model m as the minimum is determined, e.g., within a threshold value. The model smoothing operator term can also include a relative weighting A to control the update rate of model parameters that achieves a minimal number of model updates between iterations of determining the model parameters for the 1D velocity.

Thus, an objective function Φ(m) based on data misfit and prior model misfit that applies a Laplacian smoothing operator can be represented by equation (8) below:

$$Φ ( m ) = \frac{1}{2} [ {( g ( m ) - {d}_{obs} )}^{T} {C}_{d}^{- 1} ( g ( m ) - {d}_{obs} ) + {( m - {m}_{pr} )}^{T} {C}_{M}^{- 1} ( m - {m}_{pr} ) + λ {m}^{T} {L}^{T} Lm ] \qquad ( 8 )$$

In some implementations, the inverse of the travel time covariance matrix C_{d} (the inverse of C_{d} referred to as C_{d}⁻¹) includes applying a filter to the travel time covariance matrix C_{d}. For example, travel time standard deviation values from the data covariance matrix C_{d} can be filtered based on a minimum number of offsets in a common midpoint-offset bin for the corresponding seismic traces. In some implementations, applying a filter to the data covariance matrix C_{d} includes filtering for a subset of travel times standard deviations corresponding to a minimum travel time, e.g., tₘᵢₙ and maximum travel time tₘₐₓ from the seismic traces.

In some implementations, the inverse of the data covariance matrix C_{d} includes filtering the covariance data C_{d} based on a standard deviation, e.g., σ_{obs} of the observed travel times from the seismic traces. For example, data for travel times that are at least a threshold number of standard deviations from the mean and/or median travel time can be removed from the uncertainty data. In some implementations, the standard deviation is a median absolute deviation of the travel times in the observed travel time data from the seismic traces.

In step 510, the data processing system is configured to minimize the objective function Φ(m) by determining values for velocity model parameters corresponding to one or more 1D velocity models. The data processing system can apply different minimization techniques to obtain the model parameters, e.g., stochastic gradient descent, gradient descent. The data processing system is configured to determine a first set of accuracy values for the velocity model parameters, e.g., accuracy values for each one-dimensional velocity model.

The objective function Φ(m) can be minimized by applying algorithms such as Gauss-Newton to solve for the model parameters that minimize Φ(m). As an example, the objective function Φ(m) can be minimized when the derivative of the objective function or Φ′(m) is set to zero. Applying Gauss-Newton's method by using the first derivative Φ′(m) and second derivative Φ″(m) of the objective function Φ(m) provides equation (9) below for the model update at iteration k of Gauss-Newton's method:

$${m}_{k + 1} = {m}_{k} - \frac{{Φ}^{′} ( m )}{{Φ}^{″} ( m )} \qquad ( 9 )$$

The first derivative of the objective function Φ′(m) and the second derivative of the objective function Φ″ (m) can be represented by equations (10) and (11) below, respectively:

$${Φ}^{′} ( m ) = {G}^{T} {C}_{d}^{- 1} ( g ( m ) - {d}_{obs} ) + {C}_{M}^{- 1} ( m - {m}_{pr} ) + λ {L}^{T} Lm \qquad ( 10 )$$

$${Φ}^{″ ( m )} = {G}^{T} {C}_{d}^{- 1} G + {C}_{M}^{- 1} + λ {L}^{T} L \qquad ( 11 )$$

In the context of the inversion of travel times data for a 1D velocity model, the Jacobian G can be applied, in which components of the Jacobian G are represented by

$${G}_{ij} = \frac{\partial {g}_{i}}{\partial {m}_{j}} ,$$

e.g., the partial derivative of the objective function includes a partial derivative of the non-linear forward operator g (m) relative to the 1D velocity model m. These derivatives can be determined from equations (5), or equations (6) and (7), previously described in reference to FIG. 1C. In some implementations, equation (6) and (7) (reproduced below) are selected as derivatives to reduce computational complexity:

$$\frac{\partial t}{\partial {v}_{i}} = - \frac{2 {h}_{i} {v}_{n}}{{{v}_{i}}^{2} \sqrt{{{v}_{n}}^{2} - {{v}_{i}}^{2}}} for i < n ; \qquad ( 6 )$$

$$\frac{\partial t}{\partial {v}_{n}} = \frac{1}{{{v}_{n}}^{2}} [ 2 {\sum }_{i = 0}^{n - 1} \frac{{h}_{i} {v}_{i}}{\sqrt{{{v}_{n}}^{2} - {{v}_{i}}^{2}}} - x ] for i = n ; \qquad ( 7 )$$

For example, determining travel times derivatives ∂t/∂vₙ as a function of velocity vᵢ and layer depth hᵢ in equations (6) and (7), rather than as a function that additionally includes trigonometric operations of incident angles θᵢ in equations (5) previously described in reference to FIG. 1C.

By applying a number of iterations through a minimization techniques, e.g., k iterations, the Jacobian Gₖ can be linearized for the model m at iteration k.

Thus, the minimization of the objective function by applying Gauss-Newton's method can be solved by a data processing system performing iterations of equation (12) below:

$$\begin{matrix}{m}_{k + 1} = {m}_{k} - {α [ {G}_{k}^{T} {C}_{d}^{- 1} {G}_{k} + {C}_{M}^{- 1} + λ {L}^{T} L ]}^{- 1} \\ [ {G}_{k}^{T} {C}_{d}^{- 1} ( g ( {m}_{k} ) - {d}_{obs} ) + {C}_{M}^{- 1} ( {m}_{k} - {m}_{pr} ) + λ {L}^{T} {Lm}_{k} ]\end{matrix} \qquad ( 12 )$$

Equation (12) above indicates that parameters for a k+1 iteration of the model m, e.g., a vector of model parameters for the 1D velocity model, is based on the parameters from a previous iteration k of the model m. The number of iterations for equation (12) can be a fixed number, e.g., a maximum number of iterations, but can also be determined based on a convergence parameter a, e.g., providing model parameters at an iteration that provides a model update lower than a minimum value E, shown in equation (13) below:

$$\vert {m}_{i , k + 1} - {m}_{i , k} \vert < ε , ∀ i = 1 , … , M \qquad ( 13 )$$

In other words, equation (13) above can also indicate that the algorithm performs a number of iterations until updates to velocity values in the 1D velocity model are below a threshold value, e.g., a minimum value. In some implementations, the convergence parameter a is determined after performing an iteration of an algorithm to minimize the objective function, e.g., by a line search or a trust region. For example, a line search is performed to identify a direction along the objective function that reduces the objective function and computes a step size for the next iteration.

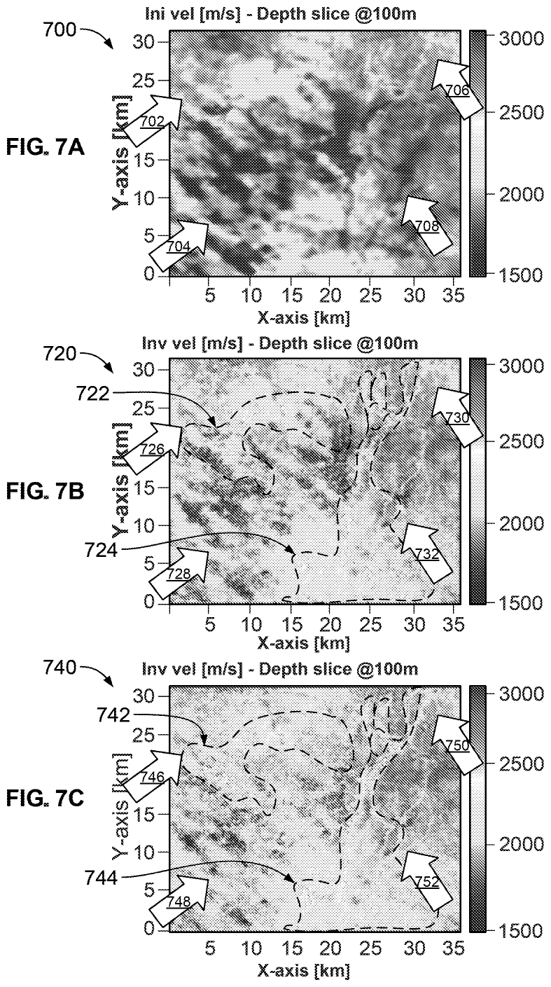

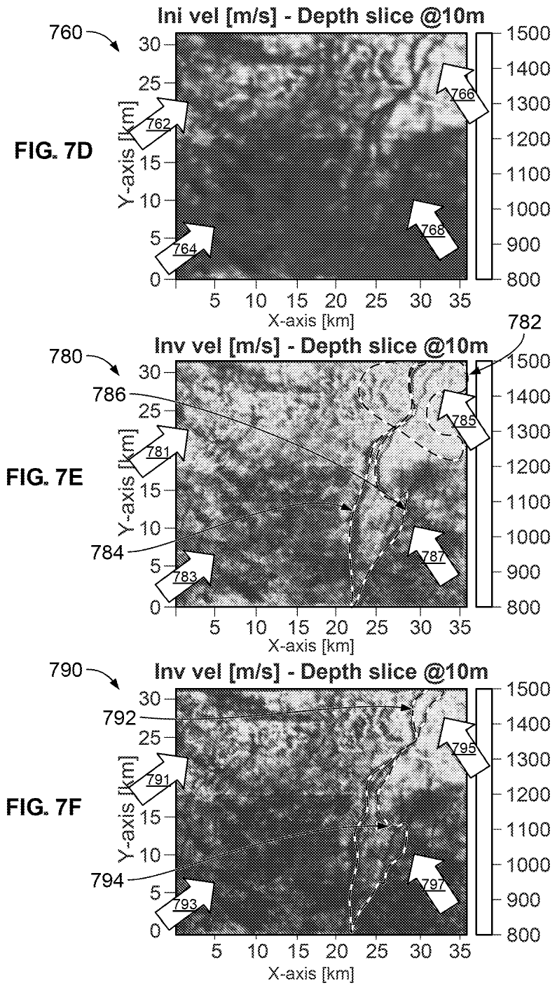

Upon determining that the model updates are within a threshold value, the data processing system can output the resulting model parameters for the 1D velocity model. The model parameters for the 1D velocity model can be used to build a velocity model at varying depths of a subterranean formation, thereby modelling the velocity profile through the layered medium of the subterranean formation. Velocity models obtained by profiles of x-y coordinates of the seismic survey at particular depths (e.g., 10 meters, 100 meters, 300 meters, 600 meters) can be used to illustrate the velocity of the refracted waves, as described in reference to FIGS. 7A-7C below.

In some implementations, non-linear transformations are applied to the model parameters of 1D velocity model m to constrain the solution for the model parameters that are bounded to physical limits, e.g., of refracted waves. Examples of physical constraints can include the velocity of the refracted waves to be higher than the propagation of sound in air.

Step 510 provides that an accuracy parameter for the 1D velocity model (including an accuracy parameter for the pseudo 3D model) can be generated based on the minimization of the objective function. For example, the minimization of the objective function to solve for model m described in Equation (12) provides a posterior model covariance matrix Ĉ_{M}, which can estimate the accuracy of the 1D velocity model m by equation (14) below:

$${\hat{C}}_{M} = {[ {G}_{k}^{T} {C}_{d}^{- 1} {G}_{k} + {C}_{M}^{- 1} + λ {L}^{T} L ]}^{- 1} \qquad ( 14 )$$

The posterior model covariance term Ĉ_{M} estimates accuracy of the 1D velocity model m by measuring uncertainty of the determined 1D velocity model, by computing the inverse of the sum of three terms: (i) the product of the transpose Jacobian Gₖ^{T} for the inverse of the data covariance matrix C_{d}⁻¹, multiplied by the Jacobian Gₖ, (ii) the inverse of the prior model covariance matrix, and (iii) the Laplacian smoothing term.

In some implementations, the generation and minimization of the objective function are updated based on a solution stability of the 1D velocity model. For example, the data processing system can determine a solution stability below a threshold value. In response to determining the measurement accuracy is below the threshold value, the data processing system updates the objective function and performs the minimization using updated model parameters, e.g., for the prior model. Minimization parameters such as convergence parameters, model update rates, and smoothing weights can also be updated.

In step 512, the data processing system is configured to generate a pseudo-3D model and corresponding values for accuracy of the pseudo-3D model. The pseudo-3D model can be generated by computing 1D velocity profiles for each seismic trace performed, e.g., at varying depths of the subterranean formation. Each 1D velocity model can provide a 1D velocity profile of x-y position coordinates, in which the pseudo-3D model can be generated by interpolating the velocity values at the 3D grid locations. Thus, a pseudo-3D model representing velocity in x-y-z position of the 3D space of the subterranean formation can be generated, e.g., generating a model for velocity of the refracted energy waves as the waves propagate through the 3D space. The accuracy parameter for each of the 1D models can also be combined to estimate an accuracy for the pseudo-3D model, e.g., combining accuracy parameters across a range of x-y-z positions. In some implementations, the data processing system can be configured to perform interpolation between two or more velocity models at different depths of the subterranean formation.

In step 514, the data processing system is configured to generate a seismic image representing the subterranean formation based on the pseudo-3D model. The seismic image can be a 3D representation of subsurface structures at varying x-y-z coordinates in the model of the subterranean formation. In some implementations, the seismic image is generated based on the pseudo-3D model and the second set of accuracy values.

In some implementations, generating the pseudo-3D model includes performing a 1D full waveform inversion (FWI) using the 1D velocity model. For example, the FWI can include velocity parameters from the 1D velocity model to generate a new and more accurate 1D velocity model.

FIG. 5B shows an example process 550 for filtering travel times data and computing a data covariance matrix of the observed travel times from seismic traces. The process 550 can be part of step 504 of process 500, previously described in reference to FIG. 5A.

The step 552 includes selecting one or more bins of seismic traces, each bin represented by one or more common midpoints (CMP). The CMP for a bin includes a corresponding two-dimensional position, e.g., as a pair of coordinates on X-Y plane, with a corresponding offset among a total number N_{O} associated for the bin. For each midpoint of the bin, a data covariance matrix can be determined based on the associated travel time of refracted waves from the bin standard deviations. A given midpoint of the bin can be located in a 3D coordinate in 3D space, such as coordinate i on the x-axis, coordinate j on the y-axis, and coordinate k indicating a particular offset among the Nₒ offsets for the bin.

By selecting the one or more bins of seismic traces, a data covariance matrix for each midpoint can be represented by equation (15) below:

$${C}_{d} ( i , j ) = [ \begin{matrix}{dpinv ( i , j , 1 )}^{2} & 0 & 0 & 0 \\ 0 & {dpinv ( i , j , 2 )}^{2} & 0 & 0 \\ 0 & 0 & … & 0 \\ 0 & 0 & 0 & {dpinv ( i , j , No )}^{2}\end{matrix} ] \qquad ( 15 )$$

The data covariance matrix dpinv for each midpoint and offset is the inverse of the observed data standard deviation for the midpoint, measuring the accuracy of the observational travel time due to the noise, for a specific midpoint i, j and an offset k.

Referring to equation (15) above, the data covariance matrix represents the covariance of travel times of refracted waves at each offset for the bin. The off-main diagonal entries for the matrix can be set to zero assuming that the observations are uncorrelated. The main diagonal elements of the data covariance matrix represent the correlations of a particular bin with respect to the same bin itself, e.g., the main diagonal elements are the variances of the travel time of the bin at the respective offset.

The step 554 includes determining one or more statistical measures of the observed travel time data. The statistical measures can include a minimum value, maximum value, a mean value, a median value, a standard deviation, a median absolute deviation, or any other statistical measure of the observed travel times for each offset in the bin. As an example, the main diagonal elements of the data covariance matrix can be represented as the square of the standard deviation from the observed travel times (also referred to as σₜₜ) for the refracted waves in the bin. For example, the data covariance matrix of the observed travel times is described by equation (16) below:

$${C}_{d} ( i , j ) = [ \begin{matrix}{{σ}_{tt} ( i , j , 1 )}^{2} & 0 & 0 & 0 \\ 0 & {{σ}_{tt} ( i , j , 2 )}^{2} & 0 & 0 \\ 0 & 0 & … & 0 \\ 0 & 0 & 0 & {{σ}_{tt} ( i , j , No )}^{2}\end{matrix} ] \qquad ( 16 )$$

In step 556, the inverse of the data covariance matrix can be generated by inverting the data covariance matrix, e.g., by a matrix inverse. For example, equation (17) below illustrates the inverse of the data covariance matrix, which can be utilized in generating and minimizing an objective function previously described in step 500 in reference to FIG. 5A:

$${C}_{d}^{- 1} ( i , j ) = [ \begin{matrix}\frac{1}{{{σ}_{tt} ( i , j , 1 )}^{2}} & 0 & 0 & 0 \\ 0 & \frac{1}{{{σ}_{tt} ( i , j , 2 )}^{2}} & 0 & 0 \\ 0 & 0 & … & 0 \\ 0 & 0 & 0 & \frac{1}{{{σ}_{tt} ( i , j , No )}^{2}}\end{matrix} ] \qquad ( 17 )$$

The process 550 can also include the step 555, in which the observed travel time data can be filtered to generate clean travel time data based on the one or more statistical measures.

The clean travel time data is a subset of travel times from observed travel time data that are within a time interval relative to measures of time distributions for the travel times. The measures of time distributions for the travel times can include statistical measures for the travel times from a common midpoint-offset bin of the corresponding seismic traces. The clean travel time data is a subset of travel times from observed travel time data that differ from their mean or any other similar statistical measure (e.g., the median) for less than a specified number of their standard deviation (e.g., 2 standard deviations, 3 standard deviations). As an example, the clean travel times can be obtained by rejecting travel times from the observed travel times that differ from the mean (or any other similar statistical measure) of the observed travel times for more than a specific number of standard deviations of the observed travel times (or any other similar statistical measure).

The statistical measures can include computing a confidence interval of travel times for the common midpoint-offset bin and selecting a subset of travel times that are within the confidence interval. In some implementations, determining the clean travel times from the travel time data includes computing a median absolute deviation (MAD), standard deviation, skewness, or other type of statistical distributions from the travel times data. The clean travel times are a subset of the travel time data that fall within the distribution at a threshold value, e.g., within a number of standard deviations from a median travel, mean travel time, or other statistical measure of the travel times.

The statistical measures can be computed in step 554 and utilized to filter the travel times in step 555, e.g., by removing seismic traces associated with outlier travel times. A first statistical measure can be computed at step 554 to determine a filter of seismic traces by the respective travel times, which is then applied at step 555. Returning to step 554, a second statistical measure can be computed prior to inverting the data covariance matrix at step 556.

As an example, a standard deviation of the clean travel times (e.g., travel times after removing seismic traces at step 555) can be represented as σ_{clean}(i,j,k) for a particular offset k among the number of offsets for the bin. Thus, the data covariance matrix for a set of clean travel times can be described by equation (18) below:

$${C}_{d ( clean )} ( i , j ) = [ \begin{matrix}{{σ}_{clean} ( i , j , 1 )}^{2} & 0 & 0 & 0 \\ 0 & {{σ}_{clean} ( i , j , 2 )}^{2} & 0 & 0 \\ 0 & 0 & … & 0 \\ 0 & 0 & 0 & {{σ}_{clean} ( i , j , No )}^{2}\end{matrix} ] \qquad ( 18 )$$

By applying step 556 to the clean travel time data from step 555, the data covariance matrix can be inverted as shown in equation (19) below.

$${C}_{d ( clean )}^{- 1} ( i , j ) = \qquad ( 19 )$$

$$[ \begin{matrix}\frac{1}{{{σ}_{clean} ( i , j , 1 )}^{2}} & 0 & 0 & 0 \\ 0 & \frac{1}{{{σ}_{clean} ( i , j , 2 )}^{2}} & 0 & 0 \\ 0 & 0 & … & 0 \\ 0 & 0 & 0 & \frac{1}{{{σ}_{clean} ( i , j , No )}^{2}}\end{matrix} ]$$

In some implementations, the filter applied to the travel times can be based on a minimum and maximum standard deviation, in which a main diagonal element of the data covariance matrix to satisfy the expression (20) below:

$$\frac{1}{{σ}_{max}} \leq \frac{1}{{σ}_{tt} ( i , j , k )} \leq \frac{1}{{σ}_{min}} \qquad ( 20 )$$

In some implementations, some or all of the main diagonal elements of the data covariance matrix can be set to a scalar (e.g., constant) value. For example, the scalar value can be based on a determined value representing a statistical measure of travel time data, e.g., including clean travel time data. For example, the determined value can be a standard deviation of the travel time data.

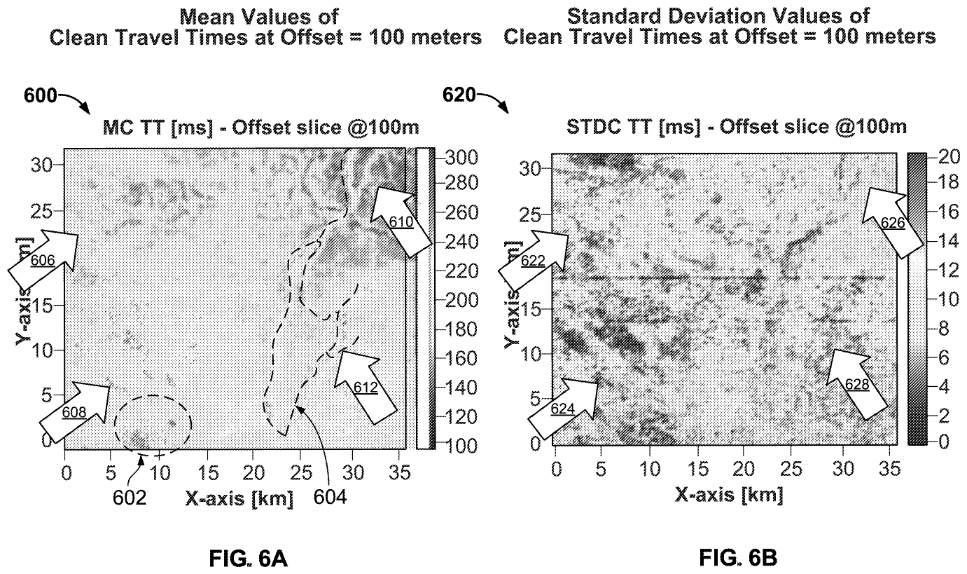

FIG. 6A depicts a plot 600 of an example of the mean values of clean travel times, such as those determined by processes 500 and 550 previously described in reference to FIGS. 5A and 5B, respectively. The plot 600 depicts a map of mean values for clean travel times in milliseconds, relative to a portion of the subterranean formation that spans approximately 35 kilometers (e.g., along the x-axis of plot 600) by 30 kilometers (e.g., along the y-axis of plot 600). The plot 600 illustrates a slice of the clean travel time cube at an offset of 600 meters, e.g., the distance between the source and receiver of the survey. The graphical arrows 606, 608, 610, and 612 point to depictions of complex geological facies identified in the plot 600. For example, higher values for mean travel-times in the plot 600 correspond to low values for velocity, which are associated to soft media (e.g., soft rock) in the subterranean formation. As another example, lower values for mean travel times in the plot 600 correspond to high values for velocity, which can be associated with hard media (e.g., hard rock).

The mean value of the travel times peaks at 300 milliseconds at a portion 602 of the plot 600, indicating a presence of complex geological facies in the subterranean formation. Additionally, a series of mean values along the paths 604 illustrated on the plot 600 indicate a presence of channels in the subterranean formation.

FIG. 6B depicts a plot 620 of an example of the standard deviation values of clean travel times, such as those determined by processes 500 and 550 previously described in reference to FIGS. 5A and 5B, respectively. The plot 620 depicts a map of standard deviation values for clean travel times in milliseconds, for the same portion and offset of the map of the subterranean formation previously described in reference to FIG. 6A. By generating clean travel times and filtering by a number of standard deviations, outlier travel times from the observed travel times can be removed from the dataset, e.g., by removing the corresponding traces of the outlier travel times. The graphical arrows 622, 624, 626, and 628 point to depictions of complex geological facies identified in the plot 620, e.g., similar to FIG. 6A described above. For example, higher values for standard deviations of travel-times in the plot 620 correspond to high variability in values for corresponding velocities. As another example, lower values for standard deviations of travel times in the plot 620 correspond to lower variability in values for corresponding velocities.

FIG. 7A depicts a plot 700 of a conversion of travel times to generate a velocity model of a subterranean formation. The plot 700 is a map of converted travel times to model velocities for the same portion (e.g., approximately 35 kilometers along the x-axis and 30 kilometers along the y-axis) subterranean formation previously described in reference to FIG. 6A. The graphical arrows 702, 704, 706, and 708 point to depictions of complex geological facies identified in the plot 700.

In contrast to FIGS. 6A and 6B, the plot 700 depicts the map as a slice at a depth of 100 meters below the surface of the subterranean formation. The plot 700 is a velocity model depth slice resulting from converting the travel times as a function of offset into velocity models as a function of depth. As discussed, the approach of converting travel time data into velocity functions do not include statistical uncertainties in the travel time data, e.g., such as plot 620 illustrating standard deviations of clean travel times. In some cases, the conversion of travel times into velocity functions includes fitting the observed travel times into a cubic spline function approximation that meets multiple constraints, e.g., by solving a least squares problem.

FIG. 7B depicts a plot 720 in which the clean travel times are inverted to generate a velocity model of the same subterranean formation previously described in reference to FIGS. 6A, 6B, and 7A. The clean travel times are inverted through the generation of an objective function that can be minimized to generate 1D velocity models of the subterranean formation, as previously described in reference to FIGS. 5A and 5B. The graphical arrows 726, 728, 730, and 732 point to depictions of complex geological facies identified in the plot 720.

In particular, the plot 720 illustrates a velocity map obtained by inverting clean travel times and using a data covariance matrix obtained by computing standard deviations of the observed data, e.g., similar to equations (18) and (19) described above.

In contrast to FIG. 7A, the plot 720 of FIG. 7B illustrates a velocity model depth slice of the subterranean feature at a higher resolution. For example, the portion 722 of plot 720 illustrates higher resolution (e.g., velocity at approximately 2800 meters per second) compared to the resolution for the same portion (e.g., a range of velocities from 1500 to 2000 meters per second) depicted in plot 700 of FIG. 7A. As another example, the portion 724 of the plot 720 also illustrates higher resolution (e.g., velocity at approximately 2500 meters per second) than resolution in the same portion (e.g., a range of velocities from 1500 to 2000 meters per second) depicted in plot 700 of FIG. 7A.

FIG. 7C depicts a plot 740 in which the clean travel times are inverted to generate a velocity model of the same subterranean formation previously described in reference to FIGS. 6A, 6B, and 7A. Similar to plot 720, the clean travel times are inverted but the data covariance matrix utilized in the objective function for the plot 720 assumes a scalar value along the main diagonal of the data covariance matrix. The covariance for each offset in the data covariance matrix is assumed to be a scalar value. The graphical arrows 746, 748, 750, and 752 point to depictions of complex geological facies identified in the plot 740.

Similar to FIG. 7B, the plot 740 illustrates improvement in resolution of seismic images by illustrating granularity in the velocity map of the seismic image. Portions 742 and 744 of the plot 740 correspond to portions 722 and 724 of the plot 720, respectively. The portion 742 of plot 740 shows higher resolution (e.g., a peak value for velocity at approximately 2800 meters per second) similar to the peak value for velocity in portion 722 of plot 720. The portion 744 of plot 740 shows higher resolution (e.g., a peak value for velocity at approximately 2500 meters per second) similar to the peak value for velocity in portion 724 of plot 720. The plot 740 illustrates that the inversion of a data covariance matrix with scalar elements in the main diagonal can result in similar improvements to accuracy depicted in plot 720. Both FIGS. 7B and 7C, e.g., plots based on inverting travel times, include plots depicting improvements in velocity modeling accuracy, with improved sharpness in the velocity models to indicate geological features that otherwise are not detected in the plot depicted in FIG. 7A, e.g., a plot based on converting travel times.

FIG. 7D is a plot 760 of another example conversion of travel times to generate a velocity model. In contrast to FIG. 7A, the depth slice depicted in plot 760 is at a depth of 10 meters below the surface of the subterranean formation. The graphical arrows 762, 764, 766, and 768 point to depictions of complex geological facies identified in the plot 760.

FIG. 7E depicts a plot 780 in which the clean travel times are inverted to generate a velocity model of the same subterranean formation previously described in reference to FIGS. 6A, 6B, and 7D. The clean travel times are inverted through the generation of an objective function that can be minimized to generate 1D velocity models of the subterranean formation, as previously described in reference to FIGS. 5A and 5B. FIG. 7E depicts portions 782, 784, and 786, each illustrating a high resolution model of the velocity for the subterranean formation at the particular depth. The graphical arrows 781, 783, 785, and 787 point to depictions of complex geological facies identified in the plot 780.

FIG. 7F depicts a plot 790 with corresponding portions 792, 794, and 796 illustrate a high resolution of the velocity for the subterranean formation at the particular depth, e.g., similar to FIG. 7E. The clean travel times for plot 790 are inverted but the data covariance matrix utilized in the objective function for the plot 790 assumes a scalar value along the main diagonal of the data covariance matrix. The covariance for each offset in the data covariance matrix is assumed to be a scalar value. FIG. 7E shows higher resolution than FIG. 7F, which means that using the travel times standard deviations is improving the result of the inversion process. The graphical arrows 791, 793, 795, and 797 point to depictions of complex geological facies identified in the plot 790.

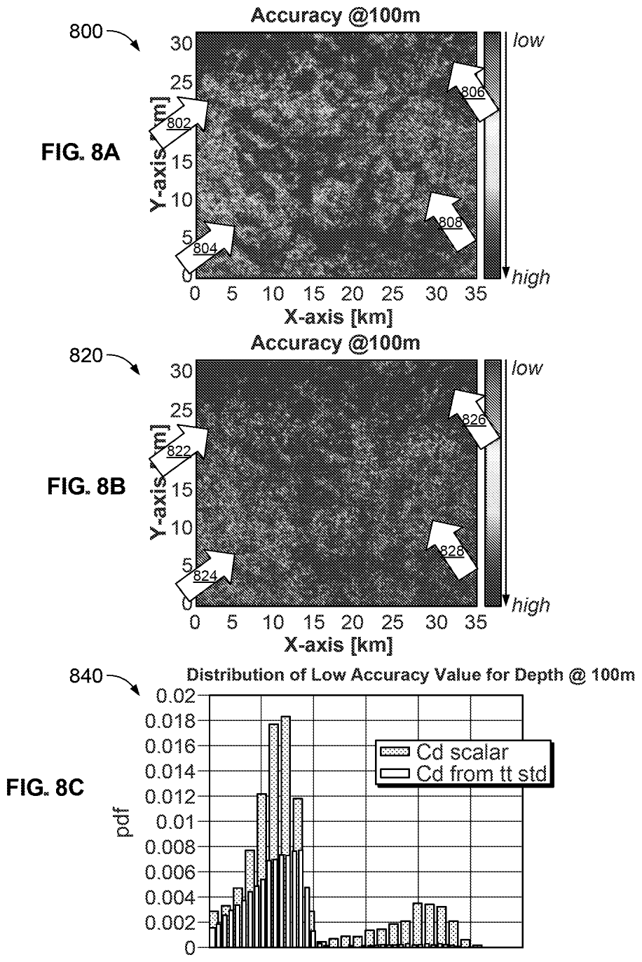

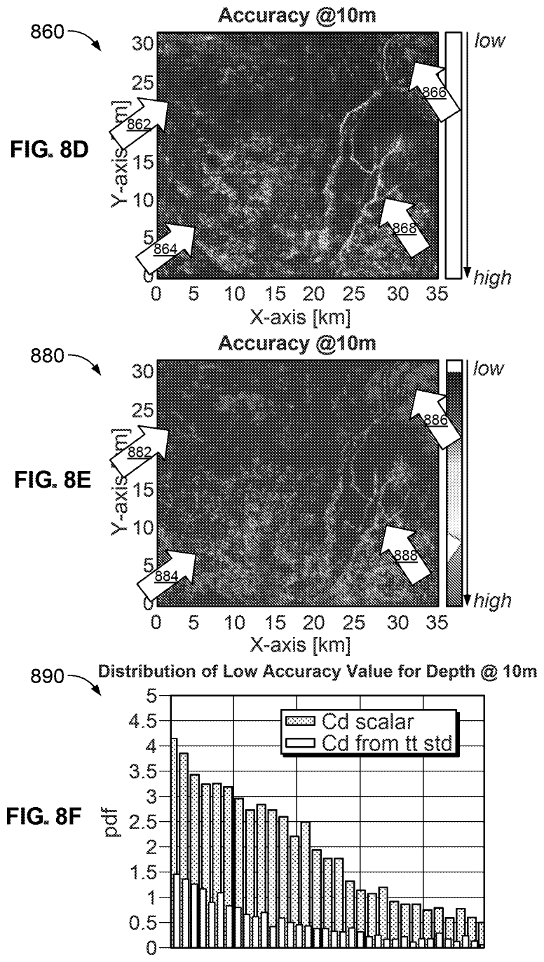

FIGS. 8A-8C are plots of example estimated accuracy of the velocities at a depth of 100 meters of the subterranean formation from inverting travel times, previously described in reference to processes 500 and 550 of FIGS. 5A and 5B.

FIG. 8A illustrates a plot 800 depicting the accuracy for the velocity map depicted in plot 720 of FIG. 7B. The plot 800 illustrates a range of velocity values between “low accuracy” and “high accuracy.” The accuracy is represented by a posterior model covariance term Ĉ_{M}, previously described in reference to equation (12). The accuracy for the velocity profile measures uncertainty of the 1D velocity model, an inversion of a sum based on three terms: (i) the product of the transpose Jacobian for the inverse of the data covariance matrix, multiplied by the Jacobian of the inverted travel times from the observed data, (ii) the inverted travel times from the inverse of the prior model covariance matrix, and (iii) the Laplacian smoothing term. As previously discussed in reference to FIG. 7B, the accuracy for the data covariance matrix of FIG. 8A is based on a data covariance matrix computed by the standard deviations of the observed data, e.g., equation (19) above. The graphical arrows 802, 804, 806, and 808 point to depictions of complex geological facies identified in the plot 800.

FIG. 8B illustrates a plot 820 depicting the accuracy for the velocity map depicted in plot 740 of FIG. 7C. Similar to plot 820, the plot 800 illustrates a range of velocity values between “low accuracy” and “high accuracy,” which is represented by a posterior model covariance term Ĉ_{M}. As previously described in reference to FIG. 7C, the accuracy for the data covariance matrix of FIG. 8A is based on a data covariance matrix that utilizes a scalar value for all main diagonal elements of the data covariance matrix. The scalar value is not based on a standard deviations of clean travel times. The graphical arrows 822, 824, 826, and 828 point to depictions of complex geological facies identified in the plot 820.

FIG. 8C illustrates a comparison of the accuracy depicted by the plot 800 and the plot 820, by a plot 840 that illustrates a comparison of probability density functions from the “low accuracy values” of plots 800 and 820.

As illustrated in the plot 840, the accuracy for a velocity map generated from an inversion of a data covariance matrix with scalar values along the main diagonal of the matrix is lower than the accuracy for a velocity map generated from an inversion of a data covariance matrix with clean standard deviation values along the main diagonal of the matrix. This is evident from the fact that the blue plot is always higher than the red plot, which means that the lower accuracy values are more frequent when the data covariance matrix has scalar values along its main diagonal.

FIGS. 8D-8F are plots of example estimated accuracy for the velocity map at a depth of 10 meters of the subterranean formation from inverting travel times, previously described in reference to processes 500 and 550 of FIGS. 5A and 5B.

FIG. 8D illustrates a plot 860 depicting the accuracy for the velocity map depicted in plot 780 of FIG. 7E. The plot 860 illustrates a range of velocity values between “low accuracy” and “high accuracy.” Similar to plot 8A, the accuracy is represented by a posterior model covariance term Ĉ_{M} and the accuracy for the velocity profile measures uncertainty of the 1D velocity model. The inversion is based on a sum of (i) the product of the transpose Jacobian for the inverse of the data covariance matrix, multiplied by the Jacobian of the inverted travel times from the observed data, (ii) the inverted travel times from the inverse of the prior model covariance matrix, and (iii) the Laplacian smoothing term. The graphical arrows 862, 864, 866, and 868 point to depictions of complex geological facies identified in the plot 860.

FIG. 8E illustrates a plot 880 depicting the accuracy for the velocity map depicted in plot 790 of FIG. 7F. Similar to plot 860, the plot 880 illustrates a range of velocity values between “low accuracy” and “high accuracy,” which is represented by a posterior model covariance term Ĉ_{M}. As previously described in reference to FIG. 7F, the accuracy for the data covariance matrix of FIG. 8E is based on a data covariance matrix that utilizes a scalar value for all main diagonal elements of the data covariance matrix. The scalar value is not based on a standard deviations of clean travel times. The graphical arrows 882, 884, 886, and 888 point to depictions of complex geological facies identified in the plot 880.

FIG. 8F illustrates a comparison of the accuracy depicted by the plot 860 and the plot 880, by a plot 890 that illustrates a comparison of probability density functions from the “low accuracy values” of plots 860 and 880.

As illustrated in the plot 890, the accuracy for a velocity map generated from an inversion of a data covariance matrix with scalar values along the main diagonal of the matrix is lower than the accuracy for a velocity map generated from an inversion of a data covariance matrix with clean standard deviation values along the main diagonal of the matrix. This is evident from the fact that the blue plot is always higher than the red plot, which means that the lower accuracy values are more frequent when the data covariance matrix has scalar values along its main diagonal.

FIG. 9 is a block diagram of an example data processing system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 924. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 924 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 904. In some implementations, any or all of the components of the computer 902, including hardware or software components, can interface with each other or the interface 906 (or a combination of both), over the system bus 904. Interfaces can use an application programming interface (API) 914, a service layer 916, or a combination of the API 914 and service layer 916. The API 914 can include specifications for routines, data structures, and object classes. The API 914 can be either computer-language independent or dependent. The API 914 can refer to a complete interface, a single function, or a set of APIs.

The service layer 916 can provide software services to the computer 902 and other components (whether illustrated or not) that are communicably coupled to the computer 902. The functionality of the computer 902 can be accessible for all service consumers using this service layer. Software services, such as those provided by the service layer 916, can provide reusable, defined functionalities through a defined interface. For example, the interface can be software written in JAVA, C++, or a language providing data in extensible markup language (XML) format. While illustrated as an integrated component of the computer 902, in alternative implementations, the API 914 or the service layer 916 can be stand-alone components in relation to other components of the computer 902 and other components communicably coupled to the computer 902. Moreover, any or all parts of the API 914 or the service layer 916 can be implemented as child or sub-modules of another software module, enterprise application, or hardware module without departing from the scope of the present disclosure.

The computer 902 includes an interface 906. Although illustrated as a single interface 906 in FIG. 9, two or more interfaces 906 can be used according to particular needs, desires, or particular implementations of the computer 902 and the described functionality. The interface 906 can be used by the computer 902 for communicating with other systems that are connected to the network 924 (whether illustrated or not) in a distributed environment. Generally, the interface 906 can include, or be implemented using, logic encoded in software or hardware (or a combination of software and hardware) operable to communicate with the network 924. More specifically, the interface 906 can include software supporting one or more communication protocols associated with communications. As such, the network 924 or the hardware of the interface can be operable to communicate physical signals within and outside of the illustrated computer 902.

The computer 902 includes a processor 908. Although illustrated as a single processor 908 in FIG. 9, two or more processors 908 can be used according to particular needs, desires, or particular implementations of the computer 902 and the described functionality. Generally, the processor 908 can execute instructions and can manipulate data to perform the operations of the computer 902, including operations using algorithms, methods, functions, processes, flows, and procedures as described in the present disclosure.

The computer 902 also includes a database 920 that can hold data (for example, seismic data 922) for the computer 902 and other components connected to the network 924 (whether illustrated or not). For example, database 920 can be an in-memory, conventional, or a database storing data consistent with the present disclosure. In some implementations, database 920 can be a combination of two or more different database types (for example, hybrid in-memory and conventional databases) according to particular needs, desires, or particular implementations of the computer 902 and the described functionality. Although illustrated as a single database 920 in FIG. 9, two or more databases (of the same, different, or combination of types) can be used according to particular needs, desires, or particular implementations of the computer 902 and the described functionality. While database 920 is illustrated as an internal component of the computer 902, in alternative implementations, database 920 can be external to the computer 902.

The computer 902 also includes a memory 910 that can hold data for the computer 902 or a combination of components connected to the network 924 (whether illustrated or not). Memory 910 can store any data consistent with the present disclosure. In some implementations, memory 910 can be a combination of two or more different types of memory (for example, a combination of semiconductor and magnetic storage) according to particular needs, desires, or particular implementations of the computer 902 and the described functionality. Although illustrated as a single memory 910 in FIG. 9, two or more memories 910 (of the same, different, or combination of types) can be used according to particular needs, desires, or particular implementations of the computer 902 and the described functionality. While memory 910 is illustrated as an internal component of the computer 902, in alternative implementations, memory 910 can be external to the computer 1002.

The application 912 can be an algorithmic software engine providing functionality according to particular needs, desires, or particular implementations of the computer 902 and the described functionality. For example, application 912 can serve as one or more components, modules, or applications. Further, although illustrated as a single application 912, the application 912 can be implemented as multiple applications 912 on the computer 902. In addition, although illustrated as internal to the computer 902, in alternative implementations, the application 912 can be external to the computer 902.

The computer 902 can also include a power supply 918. The power supply 918 can include a rechargeable or non-rechargeable battery that can be configured to be either user- or non-user-replaceable. In some implementations, the power supply 918 can include power-conversion and management circuits, including recharging, standby, and power management functionalities. In some implementations, the power-supply 918 can include a power plug to allow the computer 902 to be plugged into a wall socket or a power source to, for example, power the computer 902 or recharge a rechargeable battery.

There can be any number of computers 902 associated with, or external to, a computer system containing computer 902, with each computer 902 communicating over network 924. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

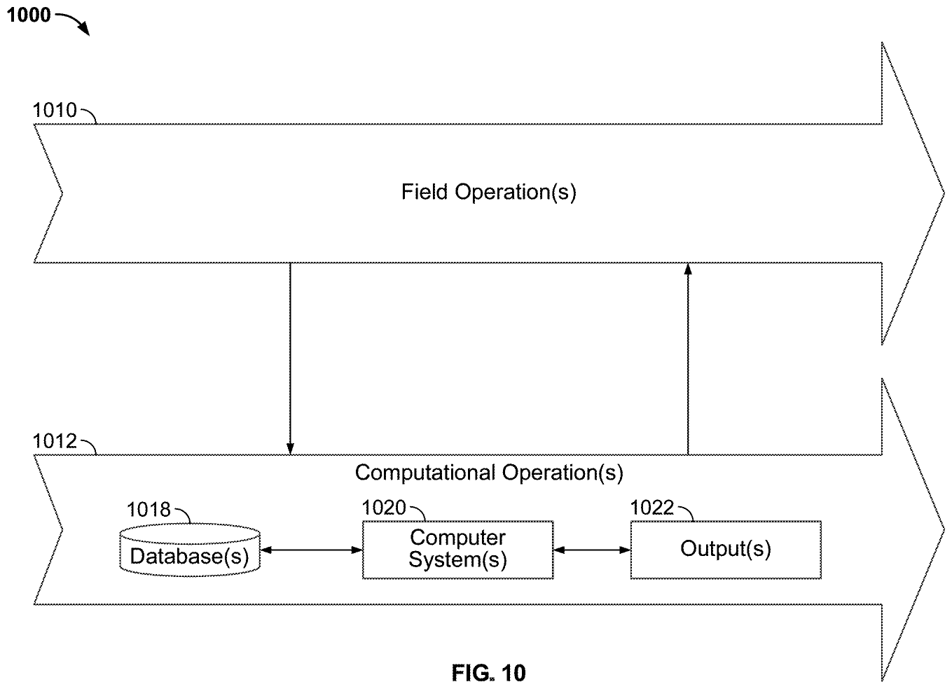

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 1002.11a/b/g/n or 1002.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the scope of the data processing system described herein. Accordingly, other embodiments are within the scope of the following claims.

What is claimed is:

1. A method for performing seismic imaging of a subterranean formation, the method comprising:
receiving, by a computer system, data representing a plurality of seismic traces corresponding to seismic waves propagating in the subterranean formation;
determining, from the plurality of seismic traces, travel time data representing observed travel times of refracted energy and a data covariance matrix representing uncertainty associated with the observed travel times for the plurality of seismic traces;
determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model;
generating an objective function based on the travel time data, the data covariance matrix, the prior velocity model, and the prior model covariance matrix;
determining, by minimizing the objective function, values for a plurality of one-dimensional velocity models and a set of accuracy values associated with the plurality of one-dimensional velocity models;
generating, based on the values for the plurality of one-dimensional velocity models and the set of accuracy values, a pseudo-3D model and a set of accuracy values for the pseudo-3D model; and
generating, based on the pseudo-3D model and the set of accuracy values for the pseudo-3D model, a seismic image representing the subterranean formation.

2. The method of claim 1, wherein each one-dimensional velocity model corresponds to a respective common midpoint location from the plurality of common midpoint locations.

3. The method of claim 1, wherein generating the pseudo-3D model comprises:
performing, by the computer system, a full waveform inversion of the travel time data using the plurality of one-dimensional velocity models.

4. The method of claim 1, wherein generating the pseudo-3D model comprises:
interpolating, by the computer system, the plurality of one-dimensional velocity models to generate the pseudo-3D model of the plurality of common midpoint locations.

5. The method of claim 1, further comprising:
determining, based on an inversion of the observed travel times and using (i) the data covariance matrix, (ii) the prior velocity model, and (iii) the prior model covariance matrix, a posterior model covariance matrix; and
determining, based on the posterior model covariance matrix, a measurement accuracy of the plurality of one-dimensional velocity models.

6. The method of claim 1, wherein the travel time data represents a subset of clean travel times from the observed travel times of refracted energy of the plurality of seismic traces, wherein the subset of clean travel times comprises travel times from the observed travel times that are within a threshold value of a first statistical measure of the observed travel times, wherein the threshold value is a second statistical measure of the observed travel times, the second statistical measure different from the first statistical measure.

7. The method of claim 1, wherein generating the objective function further comprises applying a smoothing operator to the prior velocity model.

8. The method of claim 5, wherein determining the inverse of the data covariance matrix further comprises:
applying a filter to the data covariance matrix, wherein the filter is based on a minimum number of offsets in a corresponding common midpoint-offset bin for the plurality of seismic traces.

9. The method of claim 5, wherein determining the inverse of the data covariance matrix further comprises:
applying a filter to the data covariance matrix based on a minimum travel time and a maximum travel time from the travel time data from the plurality of seismic traces.

10. The method of claim 5, wherein determining the inverse of the data covariance matrix further comprises:
applying a filter to the data covariance matrix based on a standard deviation of travel times in the travel time data from the plurality of seismic traces.

11. The method of claim 10, wherein the standard deviation is a median absolute deviation of the travel times in the travel time data from the plurality of seismic traces.

12. The method of claim 1, wherein minimizing the objective function comprises performing a number of iterations until an update for the one-dimensional velocity model is below a threshold value.

13. A system for performing seismic imaging of a subterranean formation, the system comprising:
at least one processor; and
a memory storing instructions that, when executed by the at least one processor, cause the at least one processor to perform operations comprising:
receiving, by a computer system, data representing a plurality of seismic traces corresponding to seismic waves propagating in the subterranean formation;
determining, from the plurality of seismic traces, travel time data representing observed travel times of refracted energy and a data covariance matrix representing uncertainty associated with the observed travel times for the plurality of seismic traces;
determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model;
generating an objective function based on the travel time data, the data covariance matrix, the prior velocity model, and the prior model covariance matrix;
determining, by minimizing the objective function, values for a plurality of one-dimensional velocity models and a set of accuracy values associated with the plurality of one-dimensional velocity models;
generating, based on the values for the plurality of one-dimensional velocity models and the set of accuracy values, a pseudo-3D model and a set of accuracy values for the pseudo-3D model; and
generating, based on the pseudo-3D model and the set of accuracy values for the pseudo-3D model, a seismic image representing the subterranean formation.

14. The system of claim 13, wherein generating the pseudo-3D model comprises:
performing, by the computer system, a full waveform inversion of the travel time data using the plurality of one-dimensional velocity models.

15. The system of claim 13, wherein generating the pseudo-3D model comprises:
interpolating, by the computer system, the plurality of one-dimensional velocity models to generate the pseudo-3D model of the plurality of common midpoint locations.

16. The system of claim 13, wherein the operations further comprise:
determining, based on an inversion of the observed travel times and using (i) the data covariance matrix, (ii) the prior velocity model, and (iii) the prior model covariance matrix, a posterior model covariance matrix; and
determining, based on the posterior model covariance matrix, a measurement accuracy of the plurality of one-dimensional velocity models.

17. The system of claim 13, wherein the travel time data represents a subset of clean travel times from observed travel times of refracted energy of the plurality of seismic traces, wherein the subset of clean travel times comprises travel times from the observed travel times that are within a threshold value of a first statistical measure of the observed travel times, wherein the threshold value is a second statistical measure of the observed travel times, the second statistical measure different from the first statistical measure.

18. The system of claim 13, wherein determining the inverse of the data covariance matrix further comprises:
applying a filter to the data covariance matrix, wherein the filter is based on at least one of (i) a minimum number of offsets in a corresponding common midpoint-offset bin for the plurality of seismic traces, (ii) a minimum travel time and a maximum travel time from the travel time data from the plurality of seismic traces, or (iii) a standard deviation of travel times in the travel time data from the plurality of seismic traces.

19. One or more non-transitory computer readable media storing instructions to perform seismic imaging of a subterranean formation, the instructions, when executed by at least one processor, configured to cause the at least one processor to perform operations comprising:
receiving, by a computer system, data representing a plurality of seismic traces corresponding to seismic waves propagating in the subterranean formation;
determining, from the plurality of seismic traces, travel time data representing observed travel times of refracted energy and a data covariance matrix representing uncertainty associated with the observed travel times for the plurality of seismic traces;
determining, based on the travel time data, a prior velocity model and a prior model covariance matrix for a plurality of common midpoint locations associated with the plurality of seismic traces, wherein the prior velocity model represents an initial estimate of velocities for the plurality of common midpoint locations and the prior model covariance matrix represents an uncertainty of the prior velocity model;
generating an objective function based on the travel time data, the data covariance matrix, the prior velocity model, and the prior model covariance matrix;
determining, by minimizing the objective function, values for a plurality of one-dimensional velocity models and a set of accuracy values associated with the plurality of one-dimensional velocity models;
generating, based on the values for the plurality of one-dimensional velocity models and the set of accuracy values, a pseudo-3D model and a set of accuracy values for the pseudo-3D model; and
generating, based on the pseudo-3D model and the set of accuracy values for the pseudo-3D model, a seismic image representing the subterranean formation.

20. The one or more non-transitory computer readable media of claim 19, wherein generating the pseudo-3D model comprises:
interpolating, by the computer system, the plurality of one-dimensional velocity models to generate the pseudo-3D model of the plurality of common midpoint locations.
